(19) United States
(12) Patent Application Publication
(10) Pub. No.: US 2019/0018827 A1
(43) Pub. Date: Jan. 17, 2019

(54) ELECTRONIC CONTENT INSERTION SYSTEMS AND METHODS

(71) Applicant: GOOGLE INC., Mountain View, CA (US)

(72) Inventors: Zachary Daniel ALCORN, Sunnyvale, CA (US); Jennifer CHEN, San Francisco, CA (US); Alexander Friedrich KUSCHER, San Francisco, CA (US); Trond Thomas WUELLNER, Mountain View, CA (US)

(21) Appl. No.: 15/648,369

(22) Filed: Jul. 12, 2017

(51) Int. Cl. G06F 17/24; G06F 17/30

(52) U.S. Cl. CPC G06F 17/24; G06F 17/30967

(57) ABSTRACT

Aspects of the subject technology relate to systems and methods for instant insert of external content into a content-editor application. An assistant application is provided, separate from the content-editor application, that can identify, obtain, and insert the external content into the content-editor application. The assistant application can identify the external content responsive to a user request while the user is inputting or editing content in the content-editor application and/or the assistant can provide predictive options for insertion of content based on the already input content by the user. As one example, the assistant can insert a photo related to text the user has recently typed into the content-editor application. The assistant may obtain the photo from a public source such a public web server or from a local database for the user.

### BACKGROUND

### Field

The present disclosure generally relates to electronic content editing, and more particularly to automatic insertion of content in a content editor.

### Description of the Related Art

Electronic devices such as laptop computers, netbook or cloudbook computers, tablets, smartphones, desktop computers and the like often include software such as content-editing applications that allow a user to create and edit content. Content-editing applications can include word-processing applications, presentation-editing applications, music-editing applications, video-editing applications and the like.

The description provided in the background section should not be assumed to be prior art merely because it is mentioned in or associated with the background section. The background section may include information that describes one or more aspects of the subject technology.

### SUMMARY

The disclosed subject matter relates to systems and methods for seamless insertion of external content into a content-editor application using an assistant application running within or separately from the content-editor application.

In accordance with various aspects of the subject disclosure, a computer-implemented method, is provided that includes receiving, at an assistant application while operating a content-editor application, an assistance request from a user of the content-editor application. The method also includes identifying, with the assistant application and responsive to the assistance request, content that is external to the content-editor application. The method also includes obtaining the identified content with the assistant application. The method also includes inserting the obtained content into the content-editor application with the assistant application.

In accordance with various aspects of the subject disclosure, a system is provided that includes one or more processors and a memory device including processor-readable instructions, which when executed by the one or more processors, configure the one or more processors to perform operations. The operations include receiving, at an assistant application while operating a content-editor application, an assistance request from a user of the content-editor application. The operations also include identifying, with the assistant application and responsive to the assistance request, content that is external to the content-editor application. The operations also include obtaining the identified content with the assistant application. The operations also include inserting the obtained content into the content-editor application with the assistant application.

In accordance with various aspects of the subject disclosure, a non-transitory machine-readable medium is provided that includes code to receive, at an assistant application while operating a content-editor application, an assistance request from a user of the content-editor application. The non-transitory machine-readable medium also includes code to identify, with the assistant application and responsive to the assistance request, content that is external to the content-editor application. The non-transitory machine-readable medium also includes code to obtain the identified content with the assistant application. The non-transitory machine-readable medium also includes code to insert the obtained content into the content-editor application with the assistant application.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example system for practicing some implementations of the disclosure.

FIG. 2 is a schematic diagram of a content-editor application according to certain aspects of the disclosure.

FIG. 3 is another schematic diagram of a content-editor application according to certain aspects of the disclosure.

FIG. 4 illustrates an example process for providing instant insert of external content in a content-editor application according to certain aspects of the disclosure.

FIG. 5 is a block diagram illustrating an example computer system with which the user device and/or servers of FIG. 1 can be implemented according to certain aspects of the disclosure.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

Users of a content-editor application running on an electronic device such as a desktop computer, a laptop computer, a tablet computer, or a mobile phone sometimes generate original content with the content-editor application (e.g., by typing text into a presentation-editing application or a word-processing application). Users also often desire to import external content into the content-editor application. A content-editor application may be a word-processing application, a presentation-editing application, a music-editing application, or a video-editing application (as examples).

In one example of a user operating a content-editor application, a user creating a slide deck with a presentation-editing application may desire to copy an image, a video clip, a link, or other content into the slide deck. However, identifying, locating, obtaining, and inserting the external content can be undesirably time consuming and typically requires the user to stop content-editing operations to perform external content acquisition operations.

The subject disclosure provides systems and methods for insertion of external content into a content-editor application using an assistant application running within or separately from the content-editor application. The assistant application identifies, obtains, and inserts the external content, which may allow the user to continue adding or editing content in parallel with the identification, obtaining, and insertion of the external content.

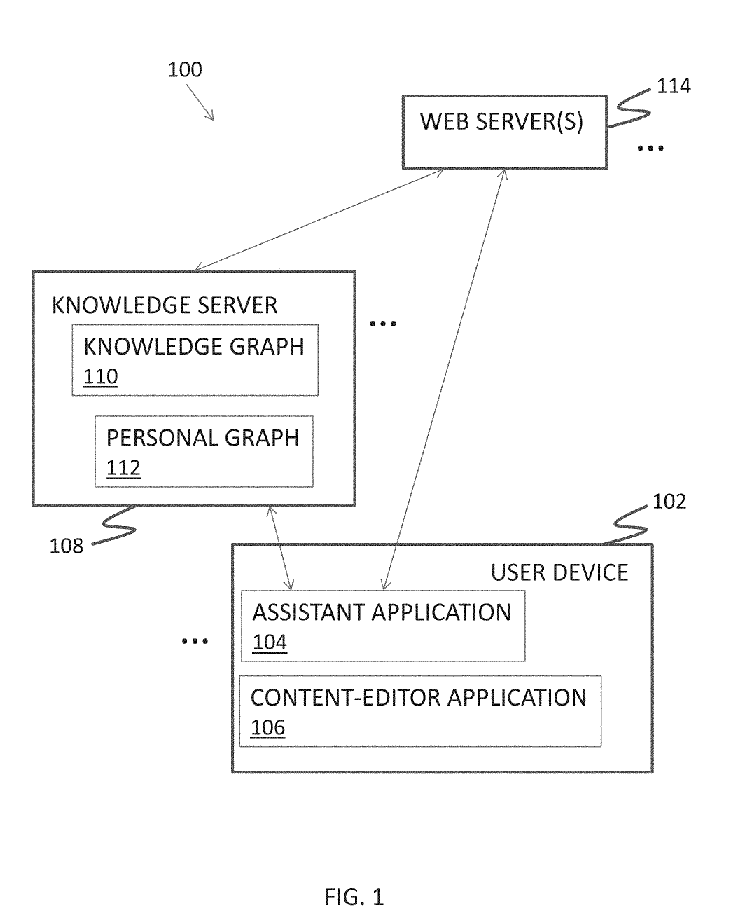

FIG. 1 shows a block diagram of an exemplary system that includes a user device 102 having a content-editor application 106 and an assistant application 104. User device 102 may be a smartphone, a tablet, a laptop computer, a desktop computer, or a convertible device that is adaptable from a laptop configuration to a tablet configuration (as examples). As shown in FIG. 1, system 100 also includes servers that are remote from user device 102 such as knowledge server 108 and one or more web servers 114. Web servers 114 host web pages that provide public and private content such as images, videos, text, articles, encyclopedic information, audio content, social media content, and/or other content available over a network such as the Internet.

Knowledge graph 110 may be a database storing identifiers of objects and storing connections between those objects, with degrees of interconnectedness. Knowledge graph objects may be real-world objects of general interest to Internet users. Personal graph 112 may be a database storing identifiers of objects and/or social contacts associated with the user of user device 102 and storing connections between those personal, user-related objects and/or contents, with degrees of interconnectedness. The stored connections and degrees of interconnectedness may facilitate faster and more accurate identification of content desired by the user for insertion. Additional details of knowledge graphs are described in, for example, U.S. Patent Publication No. 2015/0269231, which is hereby incorporated by reference herein in its entirety.

Although the diagram of FIG. 1 depicts direct communications between user device 102 and knowledge server 108, between user device 102 and web servers 114, and between knowledge server 108 and web servers 114, it should be appreciated that these communications may be exchanged via a network such as the Internet.

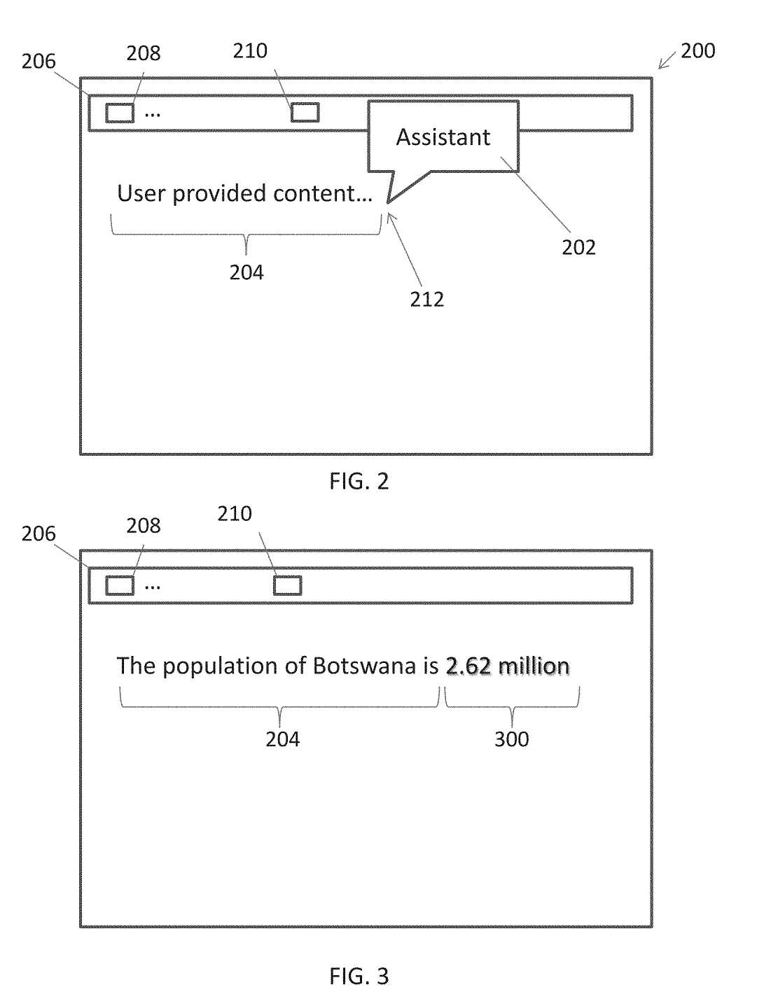

In an exemplary operation of user device 102, a user of user device 102 may be provided with a content-entry display or window by content-editor application 106. An exemplary content-entry window 200 of content-editor application 106 is shown in FIG. 2. As shown, the content-entry window 200 that may be provided may include one or more virtual control elements such as virtual control elements 208 and 210. Virtual control elements 208 and 210 may be provided in a tool bar 206 (e.g., a header toolbar as shown or a footer or dock toolbar) or elsewhere in the content-entry view 200. Tool bar 206 may be a floating tool bar within the content entry window or may be a separate element from the content entry window in which user-entered content is entered. Virtual control elements 208 and 210 may be virtual buttons that, when selected (e.g., by a mouse click or a screen touch by the user) provide content-editing or other options for the user. For example, control element 208 may, when accessed, provide text formatting options, content review options, display view options, file management options or other options commonly found in a content-editor application such as a word processor, a presentation editor, or a video or audio production application. Selection of control element 208 may provide access to a menu or a sub-menu of additional selectable control elements.

Virtual control element 210 may be a link to assistant application 104. Virtual control element 210 may, when accessed, provide an assistance request to assistant application 104 to invoke assistant application 104. Control element 210 may be provided as an element of content-editor application 106 as shown in FIG. 2 or may be a separate control element (e.g., a control element provided on a portion of the display of device 102 other than the content-entry view of the content-editor application such as in a global header bar, a dock, etc.). The assistance request may be provided directly to assistant application 104 (e.g., without using the resources or code of content-editor application 106) or may be provided to assistant application 104 by content-editor application 106 (e.g., by providing, with content-editor application 106 a request to the operating system of user device 102 to start assistant application 104 and/or establish a communications channel between content-editor application 106 and assistant application 104).

User device 102 may also, or alternatively, be provided with a dedicated physical button (e.g., a mechanical button or a touch key) for invoking assistant application 104. In some operational scenarios, assistant application 104 may be run concurrently with content-editor application 106 and may include an active-listening function by which assistance from the assistant application can be invoked by a voice command from the user.

Invoking the assistant application may include starting up the assistant application and/or providing a visual or audio request entry option to the user. An audio request entry option may be an audio message provided via one or more speakers of user device 102 such as an electronic voice speaking a message such as “How can I help you?” or “How can I be of assistance?”. Responsively, a voice query may be provided to assistant application 104 via a microphone of device 102.

FIG. 2 shows an example of a visual request entry option that may be provided within, or otherwise in association with, content editor window 200. As shown in FIG. 2, an assistant callout window 202 may be provided within the content entry window 200, responsive to the user providing an assistance request (e.g., by selecting virtual control element 210 or by speaking a voice command such as “Assistance please.”) to assistant application 104. In the example of FIG. 2, callout window 202 is provided at a location 212 associated with recently entered content 204 from a user. In the example of FIG. 2, the recently entered content 204 is represented as text (e.g., “User provided content . . . ”).

In one example scenario, a user using content-editor operation 106 may type text into the content entry window 200. After entering the text (e.g., “User provided content”), the user may invoke the assistant application by providing an assistance request (e.g., by selecting virtual control element 210 or by speaking “Assistance please” or the like). Assistant application callout 202 may then be provided by content-editor application 106. For example, callout 202 may be provided at the location of the cursor following the last-entered character as in the example of FIG. 2.

Callout 202 may include a text entry field into which a query to assistant application 104 can be provided by the user. In one exemplary use case, while editing a document using a content-editor application 106, a user invokes the assistant application (e.g., by selecting virtual control element 210 or by speaking “Assistance please.” or the like) and provides an assistance query (e.g., via voice or typed text into callout 202) such as a request to insert content into the document. For example, the assistant application may receive a text or voice query such as “insert a photo of a puppy”. Responsively, the assistant application identifies and obtains the queried content (e.g., an image of a puppy) and inserts the obtained content into the document (e.g., at the location 212 of the callout 202). The content (e.g., the image of the puppy) can be identified, obtained, and inserted without any further interaction from the user or, in some scenarios, a selectable set of images of puppies can be provided (e.g., in a list or a carousel display) from which the user can select an image to be inserted by the assistant. In various scenarios, content-editor application 106 may receive the query and provide the query to assistant application 104 or assistant application 104 can receive the query directly from callout 202 within content-editor application 106.

In the example in which the queried content is an image of a puppy, the image of the puppy can be obtained from the user's own database (e.g., a database that is local to user device 102 on which the content-editor application and/or the assistant application are running, on a remote database such as a cloud-based database, or a social media database associated with the user) or from publicly available content on the web (e.g., accessible from one or more of servers 114 of FIG. 1). The assistant application may determine whether to obtain the content from the user's local or remote database or from the web based, in part, on the language of the assistance query. For example, in the above exemplary use case, the assistance request references “a puppy”, in which the indefinite article “a” may be an indication that a generic (e.g., web-based) image of a puppy is desired by the user.

In another example, the user may provide an assistance query to “insert an image of my puppy”, in which, the personal pronoun “my” may be interpreted as an indication from the user that a puppy image from the user's own photo library, social media account, or email account is desired, rather than a publicly available image of another puppy. Moreover, the indefinite article “an” in both queries may indicate that the assistant application should select the image to be inserted if multiple suitable images are found.

In scenarios in which insertion of a general item (e.g., an image of a puppy) that is not associated with the user is requested, assistant application 104 may utilize knowledge graph 110 to identify the desired content. In scenarios in which insertion of an item that is personally connected to the user (e.g., an image of “my” puppy) is requested, personal graph 112 or another social graph associated with the user may be used to identify the desired content. The knowledge graph and the personal graph may be stored on a common server such as server 108 of FIG. 1 or may be stored separately on one or more remote servers or on user device 102.

Responsive to a query to assistant application 104 (a) that indicates that the assistant application should select the content to be inserted, and (b) in which multiple content items are identified that are relevant to the query, various different content items that match the query may be ranked by assistant application 104 to determine which of the multiple identified content items is to be inserted and/or to determine whether to provide the user with a selection of identified content items for insertion.

In the above examples in which the content requested for insertion by the assistant application 104 are images, if assistant application 104 identifies multiple candidate images from a user database or a public database that may satisfy the query, each of the candidate images for insertion may be scored and/or ranked based on a probability of that image matching the query. If a particular candidate image has a probability greater than a threshold or exceeds all other probabilities by a different threshold, assistant application 104 may insert that image into the content-entry window 200 without further action from the user.

Accordingly, assistant application 104 may store one or more insertion thresholds such as a first probability threshold for content to be candidate content, a second probability threshold for automatic insertion (e.g., without further user input), and a difference threshold for automatic insertion. A probability above the second probability threshold may be set as a necessary but not sufficient condition for automatic insertion. For example, if two images both have a probability above the second threshold but neither probability is higher than the other by the difference threshold, a selectable set of the two candidate images may be provided to the user.

The user may be provided with adjustable assistant-insert settings that govern the insertion of content (e.g., a setting to always choose the highest ranked candidate content and insert that content or to always provide a selectable set of candidate content). The thresholds stored by assistant application 104 may also be user-adjustable, if desired.

In scenarios in which no particular image is identified for automatic insertion, the candidate images may be provided, as noted above, in a selectable set. The selectable set may be a ranked set in which the candidate images are provided in an order corresponding to the probability of that image matching the query. The candidate images may be provided within assistant callout window 202, which may be resized or reshaped to accommodate presentation of one or more selectable images for insertion.

In some scenarios, the probabilities and/or ranking of the candidate content may be determined, in part, based on existing content in the document (e.g., recently typed text or other images) and/or based on other aspects of the operating environment of the user device (e.g., other applications running on the device, internet browser tabs open on the device, and/or a browsing history stored on the device). An existing profile of the user (e.g., a personal graph) or an existing knowledge graph may be used to identify and rank the obtained content.

In some scenarios, the query can be more specific, such as a query to “insert the photo I took of Fido wearing a hat on Christmas morning.” Responsive to a specific query of this type, assistant application 104 can identify images, in the user's own database(s) based on a date (e.g., Christmas), other image metadata (e.g., a time of day of the image, or a user that captured the image), and/or the content or the image (e.g., Fido and/or a hat). In various scenarios, assistant application 104 may identify the content of the image based on the image metadata that has been stored with the image or assistant application 104 may perform image analysis operations on one or more images to identify content therein. The image analysis operations may be performed in real time during the search for the queried content or assistant application 104 may perform image analysis operations in the background during other operations of device 102 to obtain and store one or more index files for image content.

In the above example use cases, described in accordance with FIG. 2, the user invokes the assistant and provides a query (e.g., insert an image of a puppy or my puppy). However, in other circumstances, a request for assistance can be provided to the assistance application without a specific user query.

For example, when an assistance request is received via content-editor application 106, content-editor application 106 can provide recently entered user content to assistant application 104 as the query or for generation of a query. For example, as shown in FIG. 3, recently entered user content may include the text “The population of Botswana is”. This text can be provided to assistant application 104 so that assistant application 104 can generate a query without further user input.

In these circumstances, assistant application 104 may identify or construct a query based on existing content 204 in the content-editor application such as recently typed text. For example, in response to the user typing “The population of Botswana is” and invoking the assistant application, the assistant application may (i) package the recently typed text 204 into a web query such as “Botswana current population”, (ii) access one or more remote servers 114 such as search engine servers to obtain the population of Botswana responsive to the query, and (iii) generate insertion content 300 such as the text “2.62 million” indicating the obtained population. Assistant application 104 and/or content-editor application 106 may then (iv) match the formatting of the insertion text to the formatting of the recently typed text, and (v) insert the formatted insertion text at the location of the cursor when the assistant application was invoked. The operations of the assistant application in this exemplary scenario may be performed on a timescale in which the obtained numerical text is inserted in real time as the user continues typing additional content.

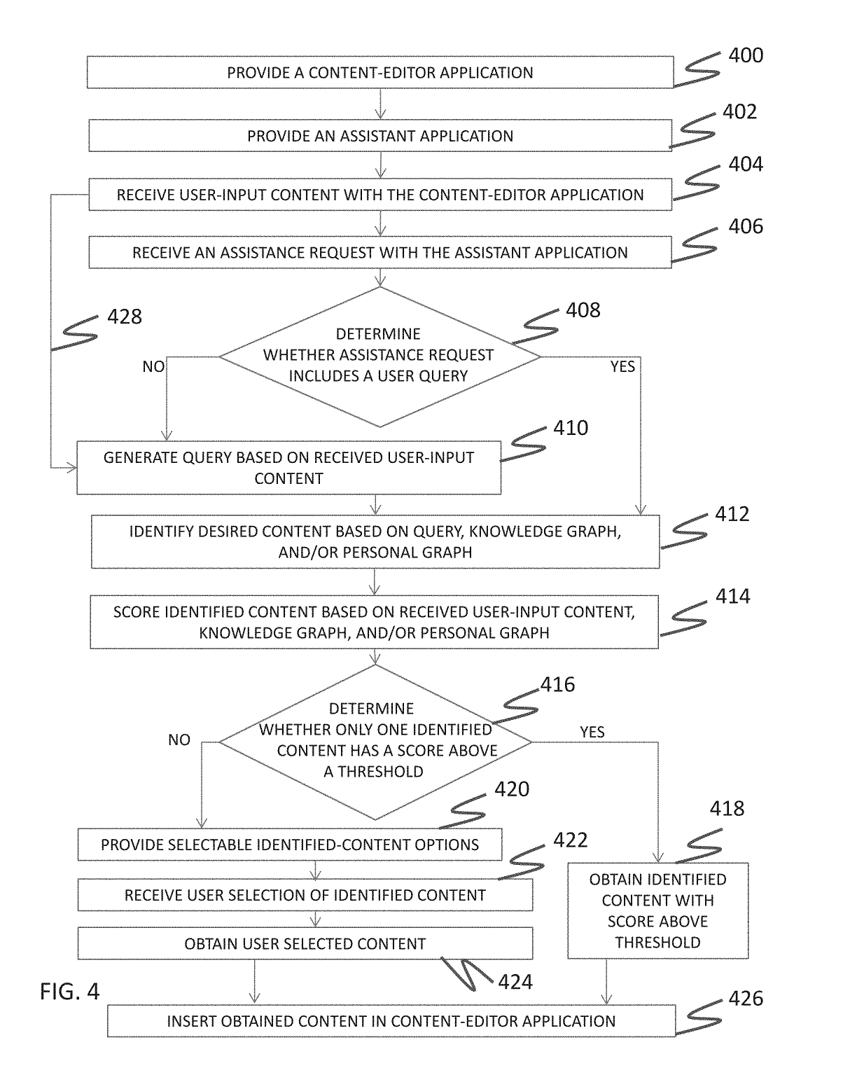

FIG. 4 depicts a flow diagram of an example process for automatic insertion of content in a content-editor application, according to aspects of the subject technology. For explanatory purposes, the example process of FIG. 4 is described herein with reference to the components of FIGS. 1-3. Further for explanatory purposes, the blocks of the example process of FIG. 4 are described herein as occurring in serial, or linearly. However, multiple blocks of the example process of FIG. 4 may occur in parallel. In addition, the blocks of the example process of FIG. 4 need not be performed in the order shown and/or one or more of the blocks of the example process of FIG. 4 need not be performed.

In the depicted example flow diagram, at block 400, a content-editor application such as content-editor application 106 of FIG. 1 is provided. The content-editor application is provided on a user device such as user device 102 of FIG. 1.

At block 402, an assistant application such as assistant application 104 of FIG. 1 is provided. The assistant application is provided on the same user device as the content-editor application as a separate application to the content-editor application.

At block 404, user-input content is received with the content-editor application. The user-input content may include typed text as in the examples of FIGS. 2 and 3, may include inserted or user-generated images or other visual content, video input, audio input, or any other content that can be provided by a user in a content-editor application.

At block 406, an assistance request is received with the assistance application. The assistance request can be received at the assistant application from the content-editor application (e.g., via a virtual button, or another selection mechanism provided within the display of the content-editor application) or can be received directly at the assistance application (e.g., via actuation of a dedicated assistant-application key on a keyboard, via a voice command from the user, or via selection of a dedicated virtual button that is separate from the display of the content-editor application).

At block 408, the assistant application determines whether the assistance request includes a user query such as “insert an image of a puppy” as described herein. The assistant application may determine whether the assistance request includes a user query by providing, responsive to the assistance request, a query entry form (e.g., in a callout 202 as shown in FIG. 2) and determining whether any query text is provided by the user in the query entry form (e.g., based on receipt of query text or receipt of a blank query or selection of an auto-query option).

If the assistant application determines that no query is provided, at block 410 the assistant application may generate a query based on the received user-input content. For example, as described above in connection with FIG. 3, assistant application 104 may generate a web query such as “Botswana current population” based in recently provided user content such as “The population of Botswana is” in the content-editor application.

As indicated by arrow 428, in some operational scenarios, the assistant application may take proactive action to provide insertable content in the content-editor application. For example, the assistant application can generate predictive queries periodically based on the most recently provided user input or responsive to each inserted word, partial word, phrase, image, video clip, audio clip or the like to provide faster query generation and/or to provide predictive options to the user for content insertion. A user-controllable setting may be provided with the assistant application or the content-editor application to enable or disable predictive query generation.

At block 412, whether the query was provided by the user (e.g., at block 406 and/or block 408), or automatically determined by the assistant application (e.g., at block 410), the assistant application identifies the desired content based on the query and, in some or all cases, a knowledge graph such as knowledge graph 110 and/or a personal graph such as personal graph 112 as described herein. Identifying the content may include performing a web search, or a search of one or more local or remote user databases based on the query.

At block 414, multiple content items identified at block 412 may be scored by the assistant application. The score for each identified content item may be a probability that that content item is a match to the query. The score for each identified content item may be determined based on the received user-input content (e.g., based on a comparison with one or more terms or other content recently entered by the user in the content-editor application), the knowledge graph, and/or the personal graph.

At block 416, the assistant application may determine whether only one of the identified content items has a score above a threshold. The threshold may be an automatic-insertion threshold such as (1) a 90%, 95%, or 99% probability (as examples) that that identified content item is a match to the query, and/or (2) a probability difference of at least 10%, 20%, or 30% higher than all other scores.

At block 418, if a single one of the identified content items has a score above the automatic insertion threshold, that identified content may be obtained. For example, obtaining that identified content may include downloading the identified content from a web server to the user device, downloading the identified content from a remote user database or obtaining the identified content from a local user database. It should be appreciated, however, that in some scenarios, the identified content may be obtained prior comparison of the content score to the threshold.

At block 420, if none of the identified content items has a score above the automatic insertion threshold, or if more than one of the identified content items has a score above the automatic insertion threshold and none has a score that is higher than the others by a difference threshold, selectable identified content items may be provided to the user within the content-editor application display. As described herein, the multiple identified content items (e.g., the set of identified content items having a score above the threshold or a set of the identified content items that have scores below the threshold such as the two, three, four, or five highest scoring content items) may be provided in a list or a carousel display for selection by the user for insertion.

At block 422, the assistant application and/or the content-editor application may receive a user-selection of one or more of the identified selectable content items for insertion. For example, the user may click, tap, or drag the desired content items for insertion.

At block 424, if the identified content was not already obtained at the time of identification, the user-selected content may be obtained (e.g., by download from one or more of web servers 114 and/or one or more user-associated databases as described herein).

At block 426, the obtained content is inserted in the content-editor application (e.g., at the location at which the assistant application was invoked, at the location of a cursor or other control icon at the time of the assistance request, or at another user-specified location). The obtained content may be inserted directly into the content-editor application display by the assistant application, or the obtained content may be provided from the assistant application to the content-editor application to be formatted and/or inserted into the content-editor application display.

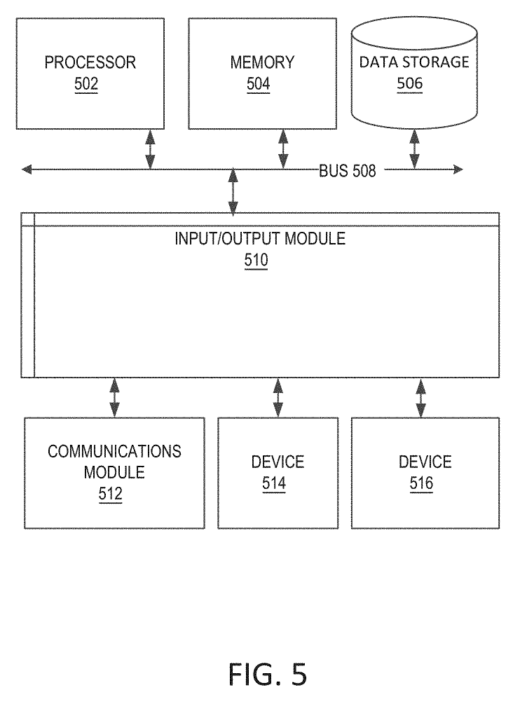

FIG. 5 is a block diagram illustrating an exemplary computer system 500 with which any one of web server(s) 114, knowledge server 108, or user device 102 of FIG. 1 can be implemented. In certain aspects, the computer system 500 may be implemented using hardware or a combination of software and hardware, either in a dedicated server, or integrated into another entity, or distributed across multiple entities.

Computer system 500 (e.g., any one of web server(s) 114, knowledge server 108, or user device 102) includes a bus 508 or other communication mechanism for communicating information, and a processor 502 coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Exemplary input/output modules 510 include data ports such as USB ports. The input/output module 510 is configured to connect to a communications module 512. Exemplary communications modules 512 include networking interface cards, such as Ethernet cards and modems. In certain aspects, the input/output module 510 is configured to connect to a plurality of devices, such as an input device 514 and/or an output device 516. Exemplary input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Exemplary output devices 516 include display devices, such as a LCD (liquid crystal display) monitor, for displaying information to the user.

According to one aspect of the present disclosure, any one of web server(s) 114, knowledge server 108, or user device 102 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 502 for execution. Such a medium may take many forms, including, but not limited to, non-volatile media, volatile media, and transmission media. Non-volatile media include, for example, optical or magnetic disks, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

Various examples of aspects of the disclosure are described below as clauses for convenience. These are provided as examples, and do not limit the subject technology.

Clause A. A computer-implemented method, comprising: receiving, at an assistant application while operating a content-editor application, an assistance request from a user of the content-editor application; identifying, with the assistant application and responsive to the assistance request, content that is external to the content-editor application; obtaining the identified content with the assistant application; and inserting the obtained content into the content-editor application with the assistant application.

Clause B. A system, comprising: one or more processors; and a memory device including processor-readable instructions, which when executed by the one or more processors, configure the one or more processors to perform operations comprising: receiving, at an assistant application while operating a content-editor application, an assistance request from a user of the content-editor application; identifying, with the assistant application and responsive to the assistance request, content that is external to the content-editor application; obtaining the identified content with the assistant application; and inserting the obtained content into the content-editor application with the assistant application.

Clause C. A non-transitory machine-readable medium, comprising: code to receive, at an assistant application while operating a content-editor application, an assistance request from a user of the content-editor application; code to identify, with the assistant application and responsive to the assistance request, content that is external to the content-editor application; code to obtain the identified content with the assistant application; and code to insert the obtained content into the content-editor application with the assistant application.

In one or more aspects, examples of additional clauses are described below.

A method comprising one or more methods, operations or portions thereof described herein.

An apparatus comprising one or more memories and one or more processors (e.g., 502), the one or more processors configured to cause performing one or more methods, operations or portions thereof described herein.

An apparatus comprising one or more memories (e.g., 504, one or more internal, external or remote memories, or one or more registers) and one or more processors (e.g., 502) coupled to the one or more memories, the one or more processors configured to cause the apparatus to perform one or more methods, operations or portions thereof described herein.

An apparatus comprising means (e.g., 502) adapted for performing one or more methods, operations or portions thereof described herein.

A processor (e.g., 502) comprising modules for carrying out one or more methods, operations or portions thereof described herein.

A hardware apparatus comprising circuits (e.g., 502) configured to perform one or more methods, operations or portions thereof described herein.

An apparatus comprising means (e.g., 502) adapted for performing one or more methods, operations or portions thereof described herein.

An apparatus comprising components (e.g., 502) operable to carry out one or more methods, operations or portions thereof described herein.

A computer-readable storage medium (e.g., 504, one or more internal, external or remote memories, or one or more registers) comprising instructions stored therein, the instructions comprising code for performing one or more methods or operations described herein.

A computer-readable storage medium (e.g., 504, one or more internal, external or remote memories, or one or more registers) storing instructions that, when executed by one or more processors, cause one or more processors to perform one or more methods, operations or portions thereof described herein.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It may be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor may they be interpreted in such a way.

1. A computer-implemented method, comprising:
receiving, at an assistant application while operating a content-editor application, an assistance request from a user of the content-editor application;
identifying, with the assistant application and responsive to the assistance request, content that is external to the content-editor application, wherein the content is identified as obtainable from a local user database, a remote user database, or a remote public database based on a language analysis of syntactic terms in the assistance request;
obtaining the identified content with the assistant application; and
inserting the obtained content into the content-editor application with the assistant application.

2. The computer-implemented method of claim 1, wherein the language analysis includes whether the syntactic terms include a personal pronoun or an indefinite article.

3. The computer-implemented method of claim 1, wherein identifying the content comprises receiving a query from the assistance request or generating the query based on existing content within the content-editor application.

4. The computer-implemented method of claim 1, wherein identifying the content comprises determining whether the assistance request is a request for web-based content, knowledge-graph based content, or personal content.

5. The computer-implemented method of claim 4, wherein the assistance request is a request for web-based content and wherein obtaining the content comprises obtaining the content from a publicly available web-based source.

6. The computer-implemented method of claim 1, wherein the assistance request is a request for personal content and wherein obtaining the content comprises obtaining the content from a database associated with the user.

7. The computer-implemented method of claim 1, wherein identifying the content comprises identifying the content based on existing content within the content-editor application and based on an existing personal graph for the user.

8. A system, comprising:
one or more processors; and
a memory device including processor-readable instructions, which when executed by the one or more processors, configure the one or more processors to perform operations comprising:
receiving, at an assistant application while operating a content-editor application, an assistance request from a user of the content-editor application;
identifying, with the assistant application and responsive to the assistance request, content that is external to the content-editor application, wherein the content is identified as obtainable from a local user database, a remote user database, or a remote public database based on a language analysis of syntactic terms in the assistance request;
obtaining the identified content with the assistant application; and
inserting the obtained content into the content-editor application with the assistant application.

9. The system of claim 8, wherein the language analysis includes whether the syntactic terms include a personal pronoun or an indefinite article.

10. The system of claim 8, wherein identifying the content comprises receiving a query from the assistance request or generating the query based on existing content within the content-editor application.

11. The system of claim 8, wherein identifying the content comprises determining whether the assistance request is a request for web-based content, knowledge-graph based content, or personal content.

12. The system of claim 11, wherein the assistance request is a request for web-based content and wherein obtaining the content comprises obtaining the content from a publicly available web-based source.

13. The system of claim 8, wherein the assistance request is a request for personal content and wherein obtaining the content comprises obtaining the content from a database associated with the user.

14. The system of claim 8, wherein identifying the content comprises identifying the content based on existing content within the content-editor application and based on an existing personal graph for the user.

15. The system of claim 8, wherein the operations further comprise:
generating, with the assistant application, a predictive query based on recently provided user input to the content-editor application.

16. The system of claim 15, wherein the operations further comprise:
providing, with the assistant application and without receiving an additional assistance request from the user, an option to insert additional external content into the content-editor application, the additional external content based on the predictive query.

17. The system of claim 16, wherein the operations further comprise:
receiving an input to the assistant application from the user accepting the option to insert the additional external content; and
inserting the additional external content into the content-editor application.

18. A non-transitory machine-readable medium, comprising instructions that, when executed by a processor, cause:
receiving, at an assistant application while operating a content-editor application, an assistance request from a user of the content-editor application;
identifying, with the assistant application and responsive to the assistance request, content that is external to the content-editor application, wherein the content is identified as obtainable from a local user database, a remote user database, or a remote public database based on a language analysis of syntactic terms in the assistance request;
obtaining the identified content with the assistant application; and
inserting the obtained content into the content-editor application with the assistant application.

19. The non-transitory machine-readable medium of claim 18, wherein the assistance request includes a query for the content.

20. The non-transitory machine-readable medium of claim 18, wherein identifying the content comprises generating a query based on existing content within the content-editor application.
